(19) United States
(12) Patent Application Publication
(10) Pub. No.: US 2010/0154628 A1
(43) Pub. Date: Jun. 24, 2010

(54) PISTON PIN DEVICE AND METHOD OF MAKING THE SAME

(75) Inventor: Fabrizio Porta, Torino (IT)

Correspondence Address: SEED INTELLECTUAL PROPERTY LAW GROUP PLLC, 701 FIFTH AVE, SUITE 5400, SEATTLE, WA, 98104, US

(73) Assignee: A.G. PORTA S.P.A., Beinasco (IT)

(21) Appl. No.: 12/644,873

(22) Filed: Dec. 22, 2009

(30) Foreign Application Priority Data
Dec. 22, 2008 (IT) TO2008A000963

(51) Int. Cl. F16J 1/10

(52) U.S. Cl. 92/187

(57) ABSTRACT

A piston pin includes a cylindrical sleeve and an insert, the insert material having a lower volume weight than that of a material of the sleeve. For instance, the insert can be made of an aluminium alloy, of titanium, of a TiAl alloy or of a composite material. The insert has a length approximately equal to, or less than, that of the sleeve and is firmly secured to the latter by force- or interference-fitting.

### CROSS-REFERENCE TO RELATED APPLICATION

This application claims priority to Italian Patent Application No. TO2008A000963, filed Dec. 22, 2008, which is incorporated herein by reference in its entirety.

### BACKGROUND

1. Technical Field

The present invention relates to a piston pin for an internal combustion engine, that is to say, to a pin-like element which has the function of articulatedly connecting each piston of an internal combustion engine to the small end of the respective connecting rod and which is usually made as an extruded cylindrical piece of steel having high mechanical strength and low surface roughness on its outer cylindrical surface.

2. Description of the Related Art

Conventional piston pins have a solid cross-section and are typically made from a unitary body of steel, which tends to be heavy, adding to a weight of a vehicle and/or engine on which they are incorporated. Furthermore, the solid nature of conventional piston pin cross-sections inhibits or prevents sufficient lubrication and transfer of fluids through or past the piston pin.

### BRIEF SUMMARY

As the current tendency in order to cut polluting emissions is to reduce the overall weight of motor vehicles by reducing the weight of each single component of the motor vehicle, from the components of the body to the components of the engine, embodiments of the present invention provide a piston pin for an internal combustion engine which has a reduced weight with respect to the prior art, without thereby leading to a non-admissible reduction in the mechanical strength and in the lifetime thereof.

According to one embodiment, a piston pin for an internal combustion engine includes a cylindrical sleeve made of a metal, and an insert made of metal or non-metal material with a length approximately equal to or less than a length of the sleeve. The insert is positioned in the sleeve, and firmly secured thereto by a force fit such as interference fit.

In one aspect, the piston pin includes an outer cylindrical sleeve of metal material, in particular of steel, and an insert of a metal or non-metal material having preferably a volume weight lower than that of the material of the sleeve, which insert is inserted into the sleeve and is firmly secured thereto by force or an interference fit to provide the piston pin with the required stiffness and mechanical strength.

This makes it possible to obtain a piston pin which, by virtue of the outer sleeve of metal material, in particular of steel, can be machined (polished or ground) so as to have the required surface roughness and which, by virtue of the inner insert of a material having a lower volume weight than that of the outer sleeve, has a lower overall weight than that of a piston pin wholly made of steel, without thereby leading to a reduction in the mechanical strength.

The insert is preferably made of one of the following materials: aluminium alloy, titanium, TiAl alloy and composite material (for instance, carbon fibre).

In one embodiment, the insert is secured to the sleeve not only by force- or interference-fitting, but also by caulking of its axially opposite ends onto the sleeve to ensure a firmer and safer coupling between the two components of the piston pin, even in case of differential thermal expansions of these components.

### BRIEF DESCRIPTION OF THE SEVERAL VIEWS OF THE DRAWINGS

Further characteristics and advantages of the invention will become clear from the following detailed description, given purely by way of non-limiting example with reference to the appended drawings, in which:

FIG. 1 is a perspective view of a piston pin for an internal combustion engine according to one embodiment;

FIG. 2 is a plan view of the piston pin of FIG. 1;

FIG. 3 is a perspective view of the sleeve of the piston pin of FIG. 1;

FIG. 4 is a perspective view showing the insert partially inserted into a hole of the sleeve of the piston pin of FIG. 1 before being driven into it;

FIG. 5 is a perspective view of a piston pin for an internal combustion engine according to another embodiment;

FIG. 6 is a perspective view of the insert of the piston pin of FIG. 5; and

FIG. 7 is a partial axial cross-sectional view of an end region of the piston pin of FIG. 5.

### DETAILED DESCRIPTION

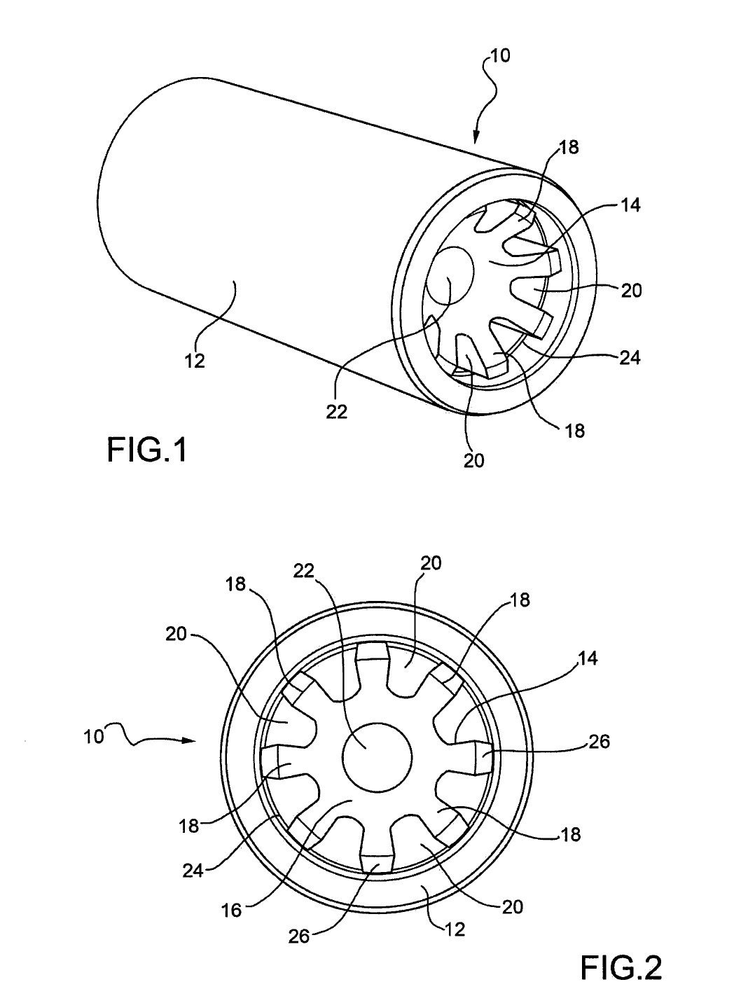

With reference first to FIGS. 1 to 4, a piston pin for an internal combustion engine according to one embodiment is generally indicated by numeral 10 and includes an outer cylindrical sleeve 12 of metal material, for example of steel, and an insert 14 of metal or non-metal material, such as a material with a lower volume weight than that of the material of the sleeve 12, which is inserted into the sleeve 12 and is firmly secured thereto to provide the piston pin 10 with the required stiffness and mechanical strength. Advantageously, a single insert 14 is provided which has a length approximately equal to, or at most slightly smaller than, that of the sleeve 12.

In one aspect, the sleeve 12 is made of steel and undergoes both case-hardening thermal treatment to increase the surface hardness, and hence the wear resistance, thereof and surface machining, in particular grinding, to reduce the surface roughness thereof.

The insert 14 is preferably made of an aluminium alloy, titanium, a TiAl alloy or a composite material, such as carbon fibre.

According to one embodiment, the insert 14 is made as a single piece comprising a core 16, which in the illustrated example has a circular cross-section, and a plurality of radial projections 18 projecting radially from the outer lateral surface of the core and extending parallel to the axis thereof so as to define between them a plurality of longitudinal cavities 20 which on the one hand serve to reduce the overall weight of the piston pin and on the other allow the lubricating oil to flow therethrough. In this way, the cross-section of the insert 14 has a star-shaped configuration. In the illustrated embodiment of FIGS. 1 to 4, the core 16 of the insert 14 has an axial through hole 22 also having both the function of reducing the overall weight of the piston pin and the function of allowing the flow of the lubricating oil. In some embodiments, the hole 22 may be omitted.

The insert 14 is firmly secured to the sleeve 12 by force- or interference-fitting. In other words, the insert 14 has an outer diameter greater than an inner diameter of the sleeve 12 and is driven into the sleeve 12. Purely by way of indication, an interference value comprised between 0.2 mm and 0.4 mm may be used. The force- or interference-fitting of the insert 14 in the sleeve 12 may also be obtained, for instance in case of an insert of aluminium alloy, by heating the sleeve 12 and, if necessary, also cooling the insert 14, so as to increase temporarily the diameter of the hole of the sleeve 12 up to a value higher than that of the outer diameter of the insert 14.

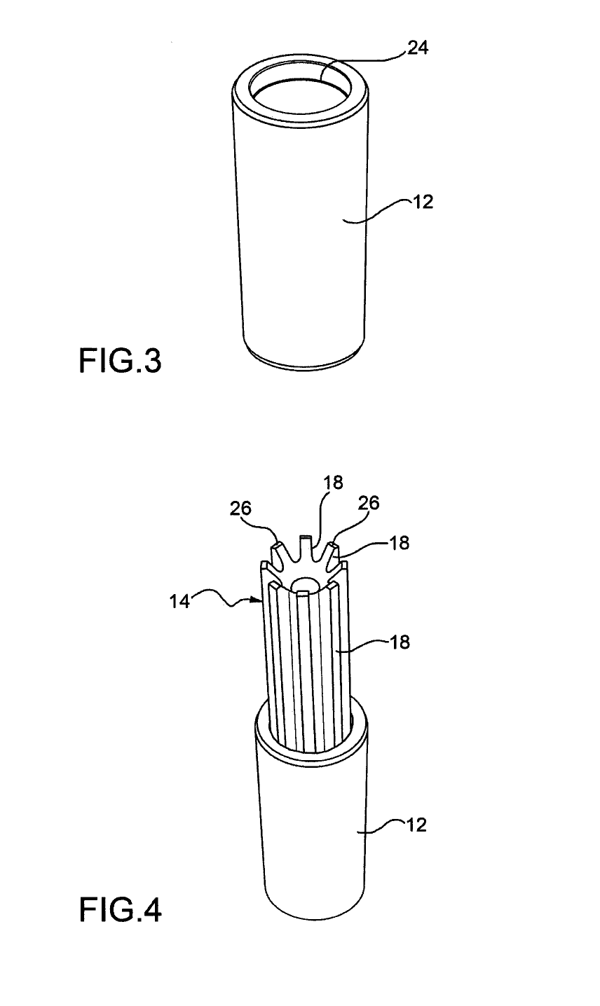

In view of a firmer and safer coupling between the sleeve 12 and the insert 14, according to a further advantageous characteristic of the invention, in case of a metal insert the axially opposite ends of the insert 14 are also caulked onto the sleeve 12. More specifically, as can be seen in particular in the perspective view of the sleeve of FIG. 3, the cylindrical inner surface of the sleeve 12 has, at each of its axially opposite ends, an annular groove 24 in which a respective axial end portion 26 of each radial projection 18 firmly engages by caulking. According to some embodiments, instead of an annular groove extending along the whole inner circumference of the sleeve 12, a plurality of notches (not shown) may be provided at each end of the sleeve 12, each notch being aligned with a respective radial projection, whereby the axial ends of the radial projections can be caulked each into a respective notch and firmly engaged therein. The caulking of the two axial ends of the insert 14 onto the inner surface of the sleeve 12 provides a further axial constraint in both directions between the insert 14 and the sleeve 12, thereby ensuring a non-releasable coupling between these two components even in case of differential thermal expansions due to the different thermal expansion coefficients of the materials of the insert and of the sleeve.

In the light of the above description, a piston pin for an internal combustion engine according to an embodiment of the present invention may be produced by a manufacturing method basically comprising the following steps:
providing the sleeve 12;
providing the insert 14;
inserting the insert 14 into the sleeve 12 and locking it therein by means of force- or interference-fitting; and in case of a metal insert, if any,
caulking the axially opposite ends 26 of the radial projections 18 of the insert 14 into an annular groove provided at a respective axial end of the inner surface of the sleeve 12.

The surface thermal treatment of the sleeve 12 and the surface machining of the sleeve 12 are carried out before and after the insertion and locking of the insert within the sleeve 12, respectively.

A piston pin obtained in the above-described manner has a weight significantly lower than that of a normal piston pin fully made as a piece of steel with the same outer diameter, by virtue of that only the sleeve of the piston pin is made of steel whereas the insert is made of a material having a lower volume weight and furthermore has a non-solid cross-section. At the same time, the piston pin according to one embodiment of the present invention has a mechanical strength not lower than that of a piston pin produced according to the prior art, by virtue of the stiffening effect provided by features and/or coupling of the insert.

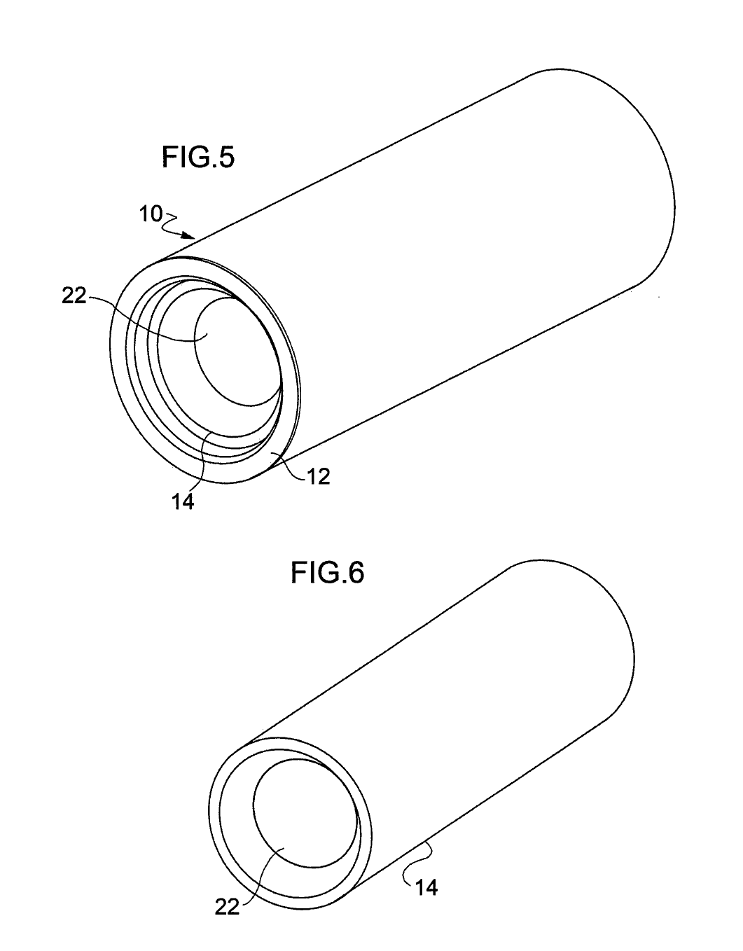

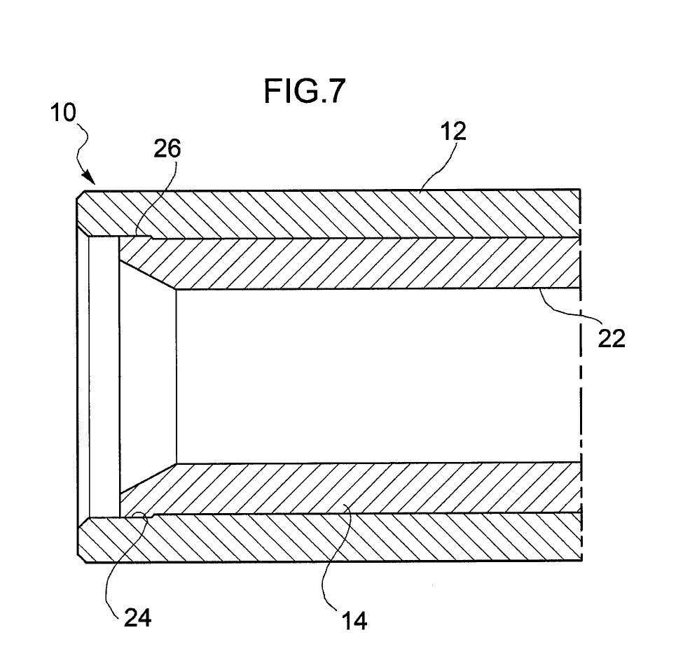

A further embodiment of a piston pin 10 for an internal combustion engine is shown in FIGS. 5 to 7, where parts and elements identical or corresponding to those of FIGS. 1 to 4 have been given the same reference numerals. This further embodiment will not be described in detail, as what has been stated before in connection with the above embodiment is substantially applicable thereto, the difference being that in this case the insert 14 is made as a tubular cylindrical element having an inner diameter and an outer diameter, the outer diameter of the insert 14 being greater than the inner diameter of the sleeve 12, whereby a force- or interference-fitting between insert 14 and sleeve 12 is obtained. In the partial axial cross-sectional view of FIG. 7 it can be seen that the insert 14 is slightly shorter than the sleeve 12 and that at each of the axially opposite ends of the sleeve 12 there is provided in the inner cylindrical surface thereof an annular groove 24 in which a respective axial end portion 26 of the insert 14 can firmly engage by caulking to provide an additional axial constraint in both directions between insert 14 and sleeve 12, thereby ensuring a non-releasable coupling between these two components even in case of differential thermal expansions due to the different thermal expansion coefficients of the materials of the insert 12 and of the sleeve 12.

Naturally, the principle of the invention remaining unchanged, the embodiments and manufacturing details may be widely varied with respect to those described and illustrated purely by way of non-limiting example.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A piston pin, comprising:
a cylindrical sleeve made of metal material; and
an insert made of metal or non-metal material with a length approximately equal to or slightly less than a length of the sleeve, the insert being inserted into the sleeve and firmly secured thereto by force- or interference-fitting.

2. The piston pin according to claim 1 wherein the sleeve is made of steel.

3. The piston pin according to claim 1 wherein the insert is made of a material having a lower volume weight than that of the material of the sleeve.

4. The piston pin according to claim 1 wherein the insert is made of one of the materials chosen from the group comprising: an aluminium alloy, titanium, a TiAl alloy or a composite material.

5. The piston pin according to claim 1 wherein the insert is made as a tubular cylindrical element.

6. The piston pin according to claim 1 wherein the insert integrally forms a core and a plurality of radial projections radially projecting from an outer lateral surface of the core and extending parallel to an axis thereof.

7. The piston pin according to claim 6 wherein the core of the insert has an axial through hole.

8. The piston pin according to claim 5 wherein the axially opposite ends of the insert are caulked into respective annular grooves or into respective notches provided on an inner surface of the sleeve.

9. The piston pin according claim 1 wherein an outer diameter of the insert is larger than an inner diameter of the sleeve.
